(19) United States
(12) Patent Application Publication
(10) Pub. No.: US 2025/0272795 A1
(43) Pub. Date: Aug. 28, 2025

(54) IMAGE ENHANCEMENT

(71) Applicant: QUALCOMM Incorporated, San Diego, CA (US)

(72) Inventors: Adil KARJAUV, Diemen (NL); Haitam BEN YAHIA, Diemen (NL); Amirhossein HABIBIAN, Amsterdam (NL)

(21) Appl. No.: 18/589,018

(22) Filed: Feb. 27, 2024

(51) Int. Cl. G06T 5/60; G06T 3/4053; G06T 5/50; G06T 5/70; G06T 11/00

(52) U.S. Cl. CPC G06T 5/60; G06T 3/4053; G06T 5/50; G06T 5/70; G06T 11/00; G06T 2207/20081; G06T 2207/20084; G06T 2207/20212; G06T 2207/30248

(57) ABSTRACT

A device includes a memory configured to store an input image. The device also includes one or more processors configured to apply synthetic noise to the input image to generate a noise-added image and to apply a denoiser to the noise-added image to generate an output image that has less noise than the input image.

### I. FIELD

The present disclosure is generally related to image enhancement.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to perform image enhancement by processing image data received from one or more image sensors. For example, a computing device can include a blind denoiser to reduce or remove noise in images. Blind denoisers are denoisers that have no information about the amount or intensity of noise present in noisy images. Conventional blind denoisers are trained using synthetic noise, such as Gaussian noise that is added to images to train the denoiser to remove noise having a Gaussian distribution. To illustrate, an amount of noise applied to a pixel can indicate a change in that pixel's value (e.g., an increase or decrease in a color value and/or luminance value of the pixel). When applying synthetic Gaussian noise to an image, the most probable amount of noise for a pixel is typically 0 (e.g., the mean of the distribution is 0), and the likelihood of a pixel value change of ±1 unit, ±2 units, etc., falls off as the amount of change (number of units) increases, in accordance with a Gaussian distribution.

However, the ability of such blind denoisers to remove noise is impaired when the noise in an image does not match the noise distribution with which the denoiser was trained. Thus, conventional blind denoisers may be unable to provide satisfactory denoising of images that include “real-world” noise that does not have a Gaussian distribution, such as noise associated with particular image sensors, lenses, camera settings, etc.

### III. SUMMARY

According to a particular implementation of the techniques disclosed herein, a device includes a memory configured to store an input image. The device also includes one or more processors configured to apply synthetic noise to the input image to generate a noise-added image and to apply a denoiser to the noise-added image to generate an output image that has less noise than the input image.

According to a particular implementation of the techniques disclosed herein, a method includes applying, at a device, synthetic noise to an input image to generate a noise-added image. The method also includes applying, at the device, a denoiser to the noise-added image to generate an output image that has less noise than the input image.

According to a particular implementation of the techniques disclosed herein, a device includes a memory configured to store an input image having a first size. The device also includes one or more processors configured to upsample the input image to generate an upsampled image that has a second size larger than the first size. The one or more processors are configured to apply a synthetic blurring kernel to the upsampled image to generate a blurred image. The one or more processors are configured to downsample the blurred image to generate a downsampled image. The one or more processors are also configured to process the downsampled image using a super-resolution model to generate an output image.

Other implementations, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram illustrating an example of an implementation of a system operable to perform image enhancement including noise reduction, in accordance with some examples of the present disclosure.

FIG. 2 is a block diagram illustrating an example of components and operations that can be implemented in the system of FIG. 1, in accordance with some examples of the present disclosure.

FIG. 3 is a block diagram illustrating an example of components and operations that can be implemented in the system of FIG. 1, in accordance with some examples of the present disclosure.

FIG. 4 is a block diagram illustrating an example of an implementation of a system operable to perform image enhancement including super-resolution, in accordance with some examples of the present disclosure.

FIG. 5 is a diagram illustrating an example of components and operations that can be implemented in the system of FIG. 4, in accordance with some examples of the present disclosure.

FIG. 6 is a block diagram illustrating an implementation of an integrated circuit operable to perform image enhancement, in accordance with some examples of the present disclosure.

FIG. 7 is a diagram of an implementation of a portable electronic device operable to perform image enhancement, in accordance with some examples of the present disclosure.

FIG. 8 is a diagram of a camera operable to perform image enhancement, in accordance with some examples of the present disclosure.

FIG. 9 is a diagram of a wearable electronic device operable to perform image enhancement, in accordance with some examples of the present disclosure.

FIG. 10 is a diagram of an extended reality device, such as augmented reality glasses, operable to perform image enhancement, in accordance with some examples of the present disclosure.

FIG. 11 is a diagram of a headset, such as a virtual reality, mixed reality, or augmented reality headset, operable to perform image enhancement, in accordance with some examples of the present disclosure.

FIG. 12 is a diagram of a voice-controlled speaker system operable to perform image enhancement, in accordance with some examples of the present disclosure.

FIG. 13 is a diagram of a first example of a vehicle operable to perform image enhancement, in accordance with some examples of the present disclosure.

FIG. 14 is a diagram of a second example of a vehicle operable to perform image enhancement, in accordance with some examples of the present disclosure.

FIG. 15 is a diagram of a particular implementation of a first method of performing image enhancement, in accordance with some examples of the present disclosure.

FIG. 16 is a diagram of a particular implementation of a second method of performing image enhancement, in accordance with some examples of the present disclosure.

FIG. 17 is a diagram of a particular implementation of a third method of performing image enhancement, in accordance with some examples of the present disclosure.

FIG. 18 is a block diagram of a particular illustrative example of a device that is operable to perform image enhancement, in accordance with some examples of the present disclosure.

### V. DETAILED DESCRIPTION

Systems and methods to perform image enhancement are disclosed. In conventional image enhancement techniques, such as blind denoising, a trained machine learning model can be used to process image data to reduce or remove noise from the image data. However, the effectiveness of such machine learning models to perform image enhancement is impaired when characteristics of an image, such as a noise distribution, significantly differs from the characteristics of images that were used to train the machine learning models. For example, conventional blind denoisers trained using images with noise having a Gaussian distribution may be unable to provide satisfactory denoising of images that include real-world noise that does not have a Gaussian distribution.

The disclosed systems and methods include techniques to apply synthetic noise to an input image to generate a noise-added image, and the noise-added image is processed by a machine learning model trained to perform image enhancement. Although application of the synthetic noise results in a noisier image than the input image, the synthetic noise is applied in a manner that causes the noise-added image to have characteristics that are more similar to the images used during training of machine learning model than characteristics of the input image are to the training images. As a result, the machine learning model is able to generate a higher quality output image by processing the noise-added image than would be generated by processing the original input image.

According to an aspect, the synthetic noise can be generated by sampling a noise distribution that matches a noise distribution of training images that were used to train a blind denoiser, and the synthetic noise is added to an input image to generate a noise-added image. The noise distribution of the noise-added image, which includes the synthetic noise combined with real-world noise from the input image, is more similar to the noise distribution of the training images upon which the denoiser was trained than the noise distribution of the original input image is to the noise distribution of the training images. Processing the noise-added image at the denoiser results in an output image that has less noise as compared to processing the original input image at the denoiser.

This counter-intuitive result—that blind denoising of a noisy image can be improved by first adding more noise to the noisy image—can be efficiently implemented in existing systems that use conventional blind denoisers, thus generalizing the effectiveness of such conventional blind denoisers to any kind of noise without knowing the underlying distribution or any other information of the noise present in the image. The present techniques can therefore be used to improve performance of a blind denoising system without requiring retraining of the blind denoiser or introducing additional memory or speed overhead.

According to some aspects, multiple synthetic noise patterns may be applied to the input image to generate multiple noise-added images, which are each processed by the denoiser to generate a corresponding output image. The output images can be combined, such as by averaging the pixel values from each of the output images, to generate an ensemble image that has less noise than any one of the output images.

The present techniques can also be applied to super-resolution processing of input images. According to an aspect, synthetic noise is applied to an input image by applying a blurring kernel to an upsampled version of the input image and downsampling the resulting image to generate the noise-added image. The noise-added image is then processed by a trained super-resolution model to generate an output image. By using a blurring kernel that matches a blurring kernel that was used to generate low-resolution training images for the super-resolution model, the resulting output image has a higher quality than would be obtained by processing the original input image using the super-resolution model.

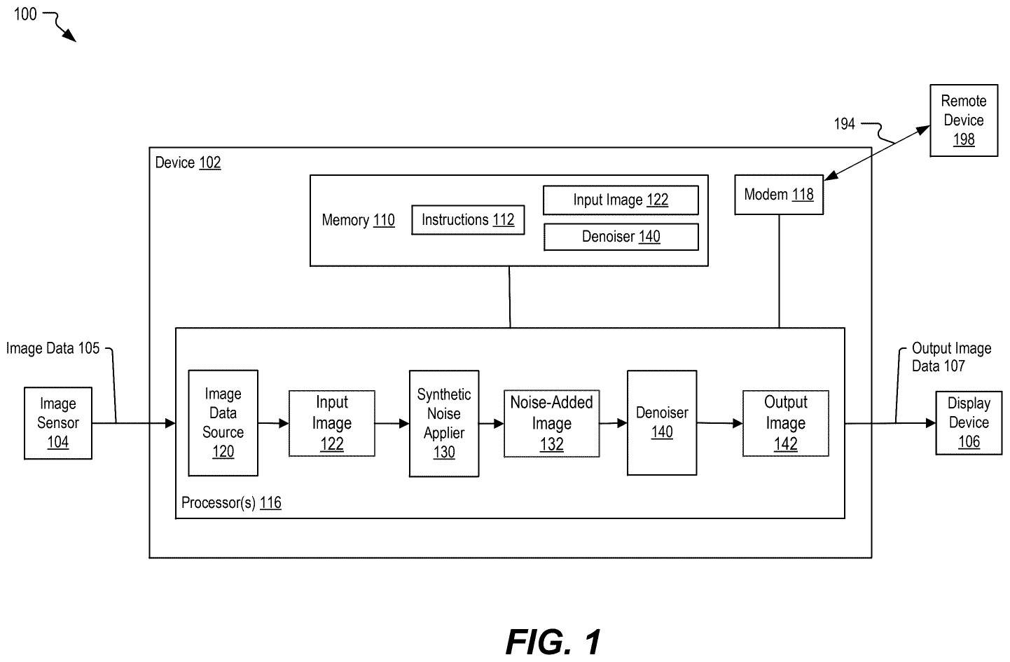

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 116 of FIG. 1), which indicates that in some implementations the device 102 includes a single processor 116 and in other implementations the device 102 includes multiple processors 116. For ease of reference herein, such features are generally introduced as “one or more” features and are subsequently referred to in the singular or optional plural (as indicated by “(s)” in the name of the feature) unless aspects related to multiple of the features are being described.

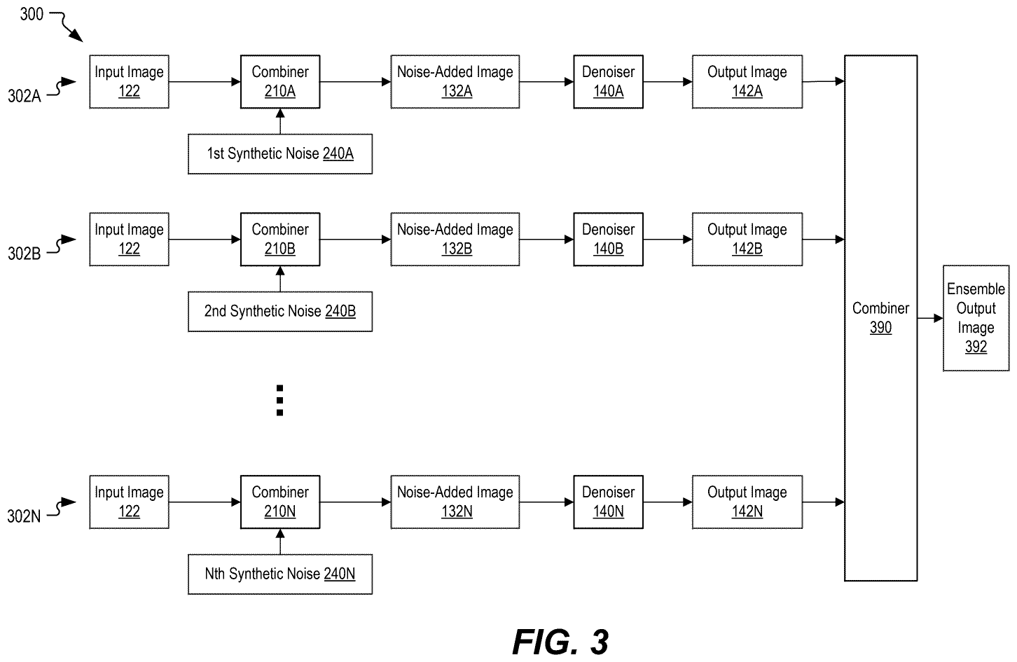

In some drawings, multiple instances of a particular type of feature are used. Although these features are physically and/or logically distinct, the same reference number is used for each, and the different instances are distinguished by addition of a letter to the reference number. When the features as a group or a type are referred to herein, e.g., when no particular one of the features is being referenced, the reference number is used without a distinguishing letter. However, when one particular feature of multiple features of the same type is referred to herein, the reference number is used with the distinguishing letter. For example, referring to FIG. 3, multiple output images 142 are illustrated and associated with reference numbers 142A, 142B, and 142N. When referring to a particular one of these output images, such as an output image 142A, the distinguishing letter “A” is used. However, when referring to any arbitrary one of these output images or to these output images as a group, the reference number 142 is used without a distinguishing letter.

As used herein, the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, retrieving, receiving, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative aspect of a system 100 is depicted that includes a device 102 that is configured to perform image enhancement. For example, the device 102 is configured to use a synthetic noise applier 130 to add synthetic noise to an input image 122, and a denoiser 140 to denoise the resulting noise-added image to generate an output image 142. Applying the synthetic noise prior to performing denoising results in the denoised output image 142 having less noise than if the input image 122 had been denoised without first applying the synthetic noise, as described further below.

Optionally, the device 102 includes, or is coupled to, an image sensor 104. The image sensor 104 is configured to generate image data 105 corresponding to the input image 122. In a particular embodiment, the image sensor 104 corresponds to or is incorporated into a camera, such as a still image camera, a video camera, a depth camera, a thermal imaging camera, one or more other types of camera, or a combination thereof. According to an aspect, the image data 105 includes data (e.g., pixel values) of individual images, video data, or a combination thereof.

The device 102 includes a memory 110 coupled to the one or more processors 116 and configured to store instructions 112 and image data, such as individual images or data corresponding to images included in video data (e.g., video frames). For example, the memory 110 may include an input image 122 to be processed at the denoiser 140, as described in further detail below. The memory 110 may also store data (e.g., parameters, such as weights and biases) associated with one or more machine learning (ML) models, such as the denoiser 140, that may be implemented at the one or more processors 116. In a particular implementation, the memory 110 corresponds to a dynamic random access memory (DRAM) of a double data rate (DDR) memory subsystem.

The one or more processors 116 are configured to execute the instructions 112 to perform operations associated with the synthetic noise applier 130 and the denoiser 140. In various implementations, some or all of the functionality associated with the synthetic noise applier 130, the denoiser 140, or both, is performed via execution of the instructions 112 by the one or more processors 116, performed by processing circuitry of the one or more processors 116 in a hardware implementation, or a combination thereof.

The one or more processors 116 may include an image data source 120 coupled to the synthetic noise applier 130 and configured to provide the input image 122 to the synthetic noise applier 130. For example, the image data source 120 may correspond to the image sensor 104, a portion of one or more of media files (e.g., a media file including the input image 122 that is retrieved from the memory 110), one or more other sources of image information, such as from a remote media server, or a combination thereof.

The input image 122 may be a “noisy” image. For example, pixels of the input image 122 may deviate from the scene represented by the input image 122. This noise—the deviation of the actual pixel values from ideal pixel values, the presence of artifacts that do not originate from the original scene of the image—corresponds to “real-world” (e.g., non-Gaussian) noise and can depend on various factors such as the particular image sensor used to capture the input image 122, a particular lens used to capture the input image 122, an amount of light incident on the image sensor, and one or more camera settings such as sensitivity (e.g., an International Organization for Standardization (ISO) value), as illustrative, non-limiting examples.

The synthetic noise applier 130 is configured to apply synthetic noise to the input image 122 to generate a noise-added image 132. According to an aspect, the synthetic noise is based on a first distribution that is associated with training of the denoiser 140, as described further below. The synthetic noise applier 130 may be configured to generate the synthetic noise, such as by sampling a particular distribution to generate, for each pixel of the input image 122, a “noise” adjustment to the pixel value of that pixel. To illustrate, a Gaussian distribution may be sampled by generating random (or pseudo-random) values having a uniform distribution between 0 and 1 and applying a Box-Muller transform to transform samples of the uniform distribution into samples of the Gaussian distribution, as an illustrative, non-limiting example. Alternatively, or in addition, the synthetic noise may be pre-generated and retrieved as one or more noise images from a storage, such as from the memory 110, and added to the input image 122 via pixel-wise addition at the synthetic noise applier 130.

The one or more processors 116 are configured to apply the denoiser 140 to the noise-added image 132 to generate an output image 142 that has less noise than the input image 122. According to an aspect, the denoiser 140 is a blind denoiser that corresponds to a trained ML model. To illustrate, the denoiser 140 may be trained using one or more training sets of noisy images that are generated by adding synthetic noise to noise-free images, performing a forward pass of the ML model to generate a model output, computing a loss function based a difference between the model output and the target noise-free image, and updating parameters of the ML model based on the loss function using a gradient estimation process (e.g., backpropagation).

The synthetic noise that is used to generate the noisy images for training the denoiser 140 may be sampled from a first distribution, such as a Gaussian distribution, that is also used to generate the synthetic noise that is applied by the synthetic noise applier 130 after the denoiser 140 has been trained. Although in some embodiments the denoiser 140 may be trained at the device 102, in other embodiments the denoiser 140 is not trained at the device 102. To illustrate, the denoiser 140 may be trained at a remote device, such as a remote device 198, and the trained denoiser 140 may be transmitted to the device 102 and stored in the memory 110. It should be understood that, although synthetic noise is used to generate training images for training the denoiser 140, the training of the denoiser 140 does not include the use of the synthetic noise applier 130 to add additional noise to a noisy input image 122 to generate the noise-added image 132; instead, the use of the synthetic noise applier 130 to generate the noise-added image 132 is performed during an inference operation of the denoiser 140 (e.g., during actual use of the denoiser 140 on real-world input images after training of the denoiser 140 has been completed).

Because the denoiser 140 is trained using noisy images based on the first distribution, the denoiser 140 may be optimized for removing noise from input images having a noise distribution that substantially matches the first distribution. However, since the real-world noise of the input image 122 is typically associated with a second distribution that is different from the first distribution, conventional processing of the input image 122 at the denoiser 140 is unlikely to produce satisfactory results. For example, the denoiser 140 operating directly on the input image 122 may remove very little of the noise in the input image 122.

By adding the synthetic noise that is based on the first distribution at the synthetic noise applier 130, the noise-added image 132 has a noise distribution that is a combination of the first distribution and the second distribution. As a result, the noise-added image 132 is more similar to the noisy images that were used to train the denoiser 140, resulting in improved denoising results in the output image 142. To illustrate, the denoiser 140 may remove most or all of the synthetic noise introduced by the synthetic noise applier 130 in addition to removing a large portion, or all, of the real-world noise that was present in the input image 122. In an illustrative example, the input image 122 includes a first amount of noise, and the output image 142 includes a second amount of noise that is less than the first amount.

Adding the synthetic noise to the input image 122 results in the noise-added image 132 having a more similar distribution as the training data of the denoiser 140, which improves the effectiveness of the denoiser 140. According to some aspects, the amount (e.g., intensity) of Gaussian noise to be added to the input image 122 is correlated to the amount of real-world noise in the input image 122. For example, relatively low amounts of synthetic noise may be effective for denoising input images having relatively low amounts of real-world noise, while higher amounts of synthetic noise may be effective for denoising input images having relatively high amounts of real-world noise. In these aspects, the synthetic noise applier 130 may add an amount of synthetic noise that is based on an amount of noise that is estimated or detected in the input image 122.

According to some aspects, adding the synthetic noise also has the effect discarding or distorting certain pixels of the input image 122, and can therefore break a spatial correlation of the noise in the input image 122, replacing some of the spatially correlated corrupted pixels in the input image 122 with Gaussian noise adjusted pixel values. As a result, the denoiser 140 may more effectively reconstruct those pixels from the surrounding inputs. In an illustrative example, real-world noise can exhibit one or more type of spatial correlation, which may appear in the input image 122 as some type of straight or curved line. Because the synthetic noise is applied pixel-wise and corrupts particular pixels of the input image 122 independently of the rest of the pixels of the input image 122, adding the synthetic noise to the input image 122 to generate the noise-added image 132 can break the spatial correlation of the real-world noise. For example, noise in the input image 122 that resembles a line might not be recognized as noise by the denoiser 140 and therefore might not be removed. However, the addition of the synthetic noise can destroy the line itself, so that the real-world noise in the noise-added image 132 is less spatially correlated than in the input image 122, improving the ability of the denoiser 140 to denoise the noise-added image 132.

In some implementations, the synthetic noise is selected based on one or more sensor settings associated with capture of the input image 122, such as an ISO sensitivity setting. For example, if the image sensor 104 was used to capture the input image 122, the one or more processors 116 may obtain the sensor setting(s) from the image sensor 104. Alternatively, or in addition, an indication of the sensor setting(s) may be included in the image data 105, in metadata of the input image 122, or both. The one or more processors 116 can determine, based on the sensor settings, one or more aspects of the synthetic noise (e.g., an intensity, mean, variance, etc.) used to generate the noise-added image 132.

In some embodiments, the one or more processors 116 are configured to apply multiple versions of synthetic noise to the input image 122 at the synthetic noise applier 130 to generate multiple noise-added images 132, and denoise each of the multiple noise-added images 132 to generate multiple output images 142. The multiple output images 142 can be combined to generate an ensemble output image, such as described further with reference to FIG. 3.

The device 102 optionally includes or is coupled to a display device 106. The display device 106 is configured to display output image data 107 corresponding to the output image 142 for viewing by a user of the device 102. In embodiments in which the one or more processors 116 generate an ensemble image from multiple output images 142, the output image data 107 may correspond to the ensemble image.

The device 102 optionally includes a modem 118 that is coupled to the one or more processors 116 and configured to enable communication with one or more other devices, such as via one or more wireless networks. According to some aspects, the modem 118 is configured to receive the image data 105, the input image 122, or both, from a second device, such as image data (e.g., included in video data) that is streamed via a wireless transmission 194 from a remote device, such as the remote device 198 (e.g., a remote server) for playback at the device 102. According to some aspects, the modem 118 is configured to send data corresponding to the output image 142 to a second device, such as image data (e.g., included in video data) that is streamed via the wireless transmission 194 to a remote device 198 (e.g., a remote server or user device) for storage or playback.

A technical advantage of adding synthetic noise to the real-world noise of the input image 122 is that the presence of the synthetic noise enables the denoiser 140 to more effectively remove the real-world noise while also removing the synthetic noise, thus improving the operation of the denoiser 140 itself and therefore improving the performance of the device 102. The resulting output image 142 can have a higher quality than is attainable by conventional blind denoisers, and thus the addition of the synthetic noise enables improved denoising performance without incurring the increased cost, computational complexity, and resource consumption associated with higher performance denoisers that are trained for specific types of real-world noise. Further, the improved denoising performance resulting from adding the synthetic noise is not limited to any particular type of real-world noise and can therefore provide generalized robust denoising of images and video from multiple sources (e.g., multiple types of cameras at multiple user devices).

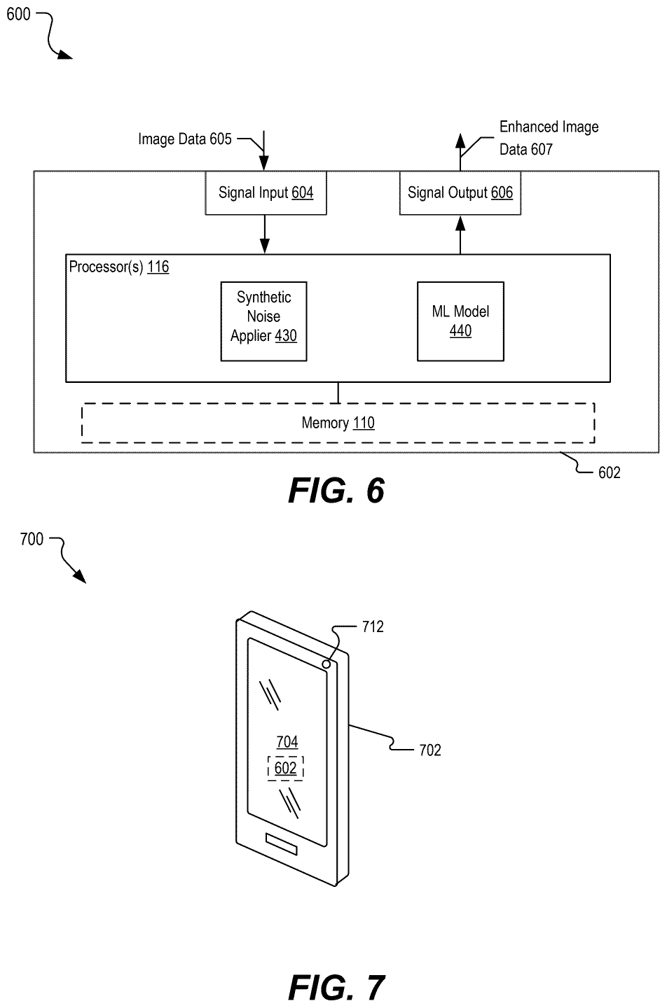

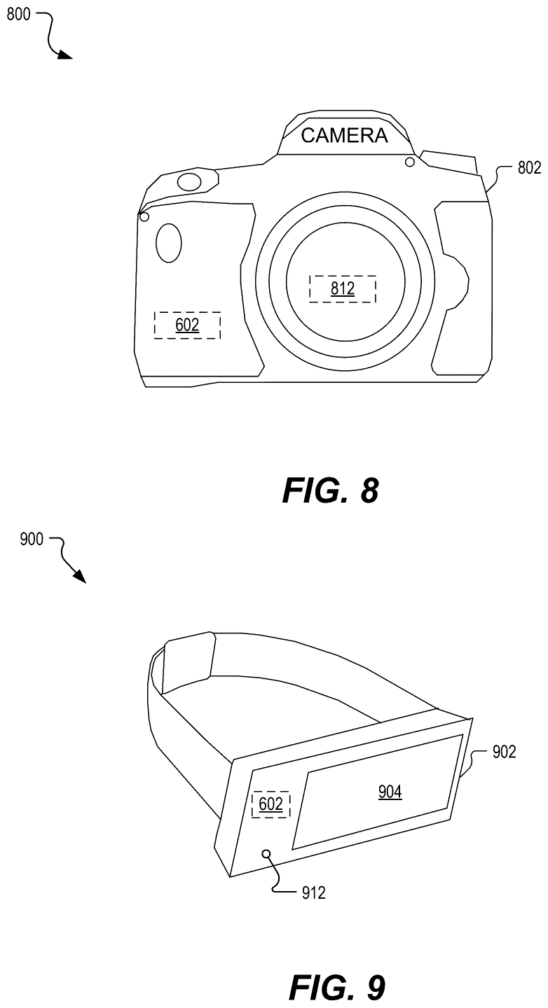

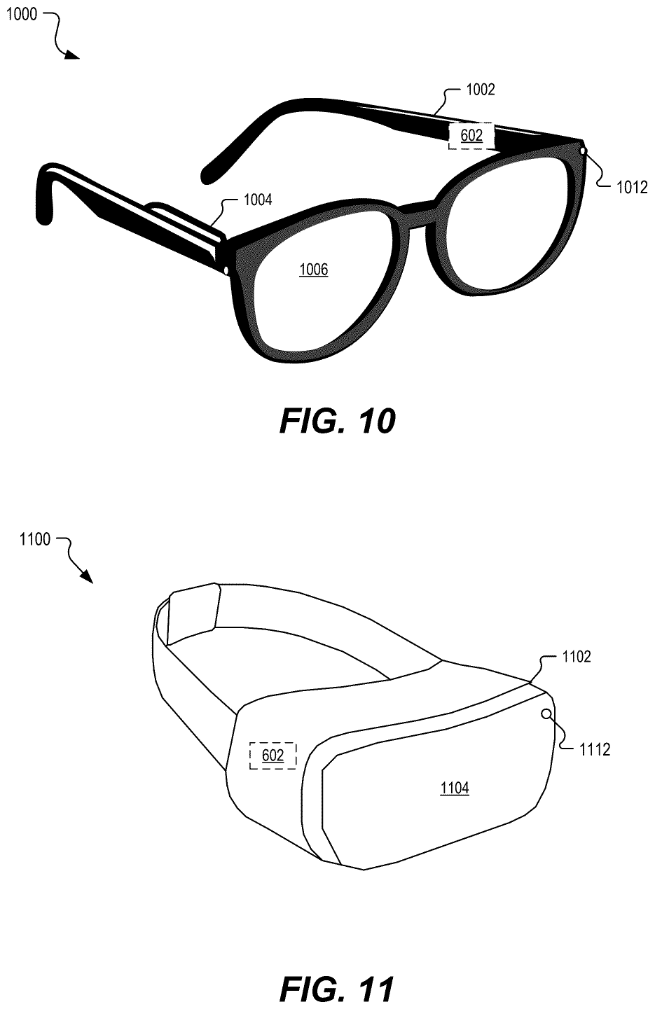

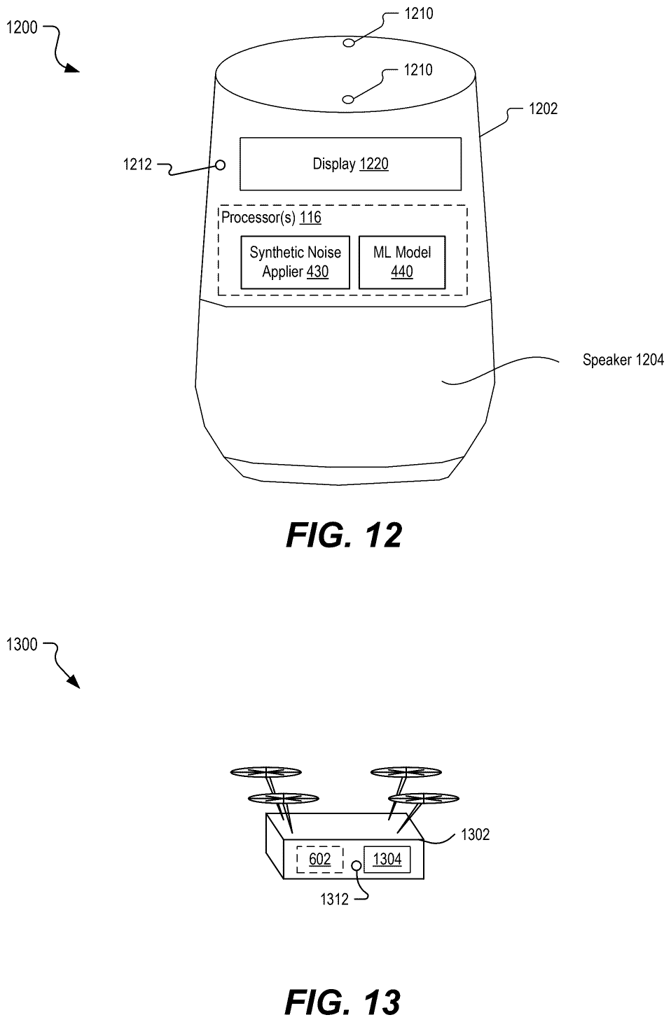

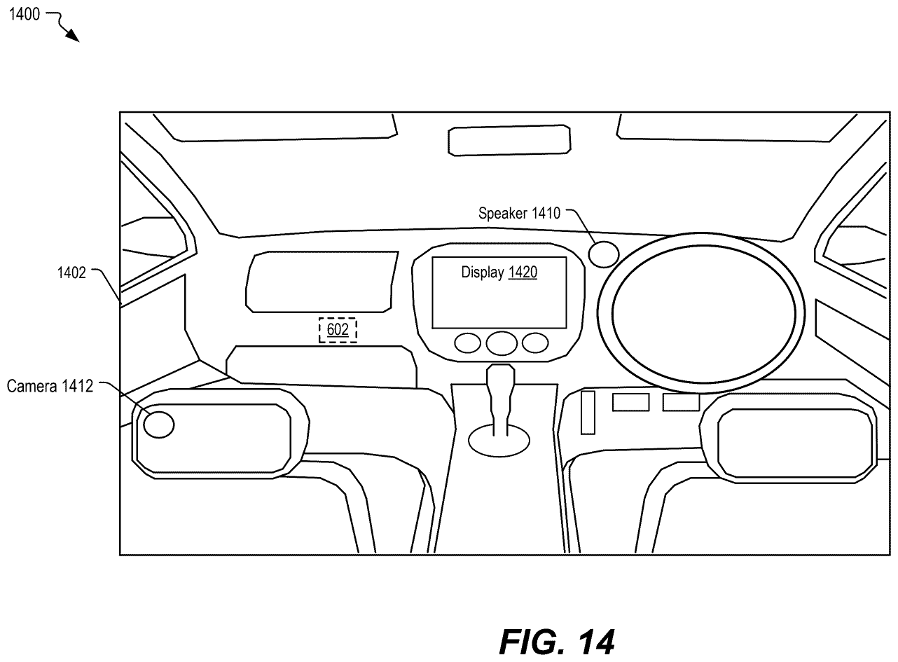

According to some aspects, the one or more processors 116 are integrated in an integrated circuit, such as illustrated in FIG. 6. According to some aspects, the one or more processors 116 are integrated in at least one of a mobile phone or a tablet computer device, such as illustrated in FIG. 7, a camera device, such as illustrated in FIG. 8, or a wearable electronic device, such as illustrated in FIG. 9. According to some aspects, the one or more processors 116 are integrated in a headset device that includes a display and that is configured, when worn by a user, to display the output image 142 at the display, such as illustrated in FIG. 10 and FIG. 11. According to some aspects, the one or more processors 116 are integrated in a voice-controlled speaker system, such as illustrated in FIG. 12. According to some aspects, the one or more processors 116 are integrated in a vehicle that also includes a display device configured to display the output image 142, such as illustrated in FIG. 13 and FIG. 14.

It should be understood that one or more aspects of the device 102 may have been omitted from the above description for clarity of explanation. For example, although in some embodiments the input image 122 matches the image data 105, the output image data 107 matches the output image 142, or both, in other embodiments the input image 122 may be the result of additional processing that is performed on the image data 105 and/or the output image data 107 may be the result of additional processing that is performed on the output image 142. Such additional processing can include cropping, zooming, tone mapping, color enhancement, upscaling, or downscaling, as illustrative, non-limiting examples.

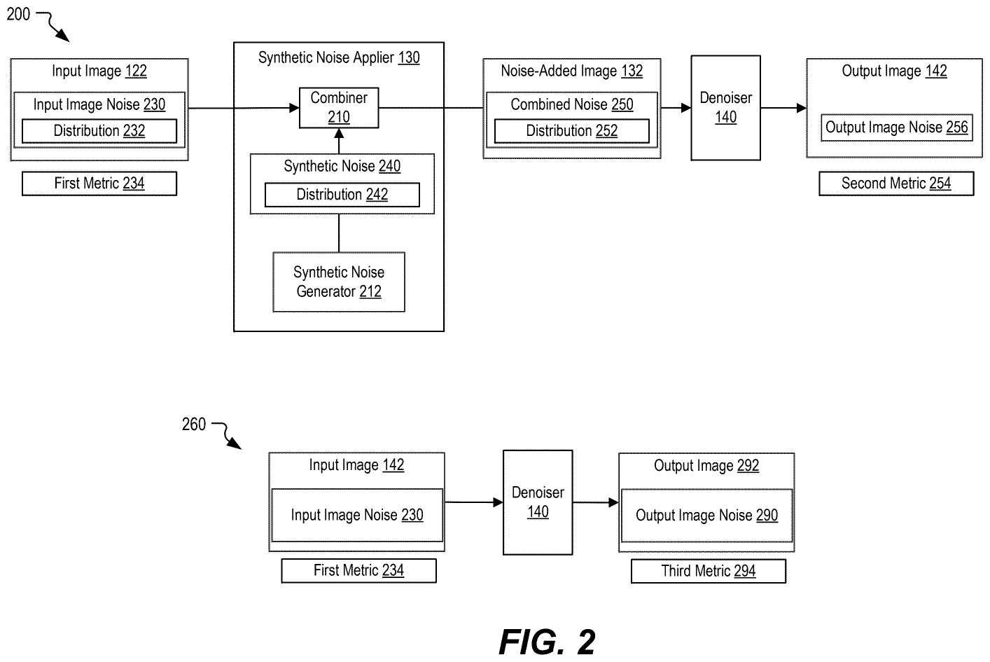

FIG. 2 depicts an example 200 of components and operations that may be implemented in the device 102 of FIG. 1, according to some examples of the present disclosure.

In the example 200, the synthetic noise applier 130 includes a synthetic noise generator 212 and a combiner 210. The synthetic noise generator 212 is configured to generate synthetic noise 240 based on a first distribution 242 that is associated with training of the denoiser 140. For example, the first distribution 242 can correspond to a Gaussian distribution that was used to generate training images for training the denoiser 140, as described with reference to FIG. 1.

The combiner 210 is configured to add the synthetic noise 240 to the input image 122 to generate the noise-added image 132. For example, the combiner 210 may perform a pixel-wise addition of the pixel value of each pixel of the input image 122 with a corresponding value of the synthetic noise 240.

The input image 122 is illustrated as including input image noise 230 that is associated with a second distribution 232 (e.g., real-world noise) that is different from the first distribution 242. The input image 122 includes a first amount of the input image noise 230, which may be quantified via a first metric 234 such as signal-to-noise ratio (SNR), peak SNR (PSNR), or mean squared error (MSE), as illustrative, non-limiting examples.

The noise-added image 132 is generated by adding the synthetic noise 240 to the input image 122 at the combiner 210. The noise-added image 132 includes combined noise 250 that corresponds to the sum of the input image noise 230 and the synthetic noise 240. The combined noise 250 has a third distribution 252 that corresponds to the sum of the first distribution 242 associated with the synthetic noise 240 and the second distribution 232 associated with the input image noise 230.

The noise-added image 132 is input to the denoiser 140, which processes the noise-added image 132 to generate the output image 142 that has less noise than the input image 122. For example, the denoiser 140, during removal of the synthetic noise 240 from the noise-added image 132, also removes at least some of the input image noise 230 of the input image 122. As illustrated, the output image 142 includes a second amount of output image noise 256, which may be quantified via a second metric 254. The second metric 254 may be of the same type as the first metric 234 (e.g., SNR, PSNR, or MSE) and have a value indicating that the amount of the output image noise 256 is less than the amount of the input image noise 230 that is indicated by the first metric 234. In some examples, the amount of the output image noise 256 is zero.

A second example 260 illustrates a comparison in which the input image 122 is processed by the denoiser 140 to generate an output image 292 that has more noise than the output image 142. As illustrated, the output image 292 has output image noise 290 that may be quantified via a third metric 294. The third metric 294 may be of the same type as the second metric 254 (e.g., SNR, PSNR, or MSE) and have a value indicating that the amount of the output image noise 290 is greater than the amount of the output image noise 256 that is indicated by the second metric 254.

Although the first distribution 242 is graphically depicted within the synthetic noise 240, the second distribution 232 is graphically depicted within the input image noise 230, and the third distribution 252 is graphically depicted within the combined noise 250, it should be understood that these distributions 232, 242, and 252 represent characteristics of the input image noise 230, the synthetic noise 240, and the combined noise 250, respectively, and are not literal data values embedded within the corresponding images or sets of noise.

In some embodiments, the one or more processors 116 of FIG. 1 perform denoising using the synthetic noise 240 with various noise intensities to find a noise intensity that gives best results. According to an example, the synthetic noise applier 130 may sweep through a sequence of parameter values when processing a first image of a video, and may use those parameters that are determined to give the best denoising results for the remainder of the video. To illustrate, the synthetic noise applier 130 may sweep through multiple different values of the variance of the first distribution 242, such as values of 5, 10, 20, 30, etc., up to the full range of allowable pixel values (e.g., the range from 0-255). The resulting output images 142 corresponding to each of the different variance values may be presented to a user (e.g., via the display device 106), and the user may select, via a user interface of the device 102, which of the resulting output images 142 has the best denoising results.

In some implementations, the one or more processors 116 may apply different synthetic noise 240 to different regions of an input image 122, or may apply the synthetic noise 240 to at least one region of the input image 122 while refraining from applying the synthetic noise 240 to at least a second region of the input image 122. Application of the synthetic noise 240 for a region can be based on quality of image (e.g., light vs. dark), based on detection of a person or other feature of interest, user-selected, or a combination thereof. To illustrate, the one or more processors 116 may generate a segmentation mask for the input image 122 and may implement application of synthetic noise differently for different regions within the segmentation mask. For example, the segmentation mask may identify regions of the input image 122 occupied by a person or a particular object, and only those regions may be denoised. In some implementations, adding the synthetic noise 240 may result in a loss of detail, so a selection may be made to denoise face regions more, but to keep noise in textured areas to minimize loss of detail.

In some implementations, the one or more processors 116 may select an amount of denoising to apply based on the pixel values of the input image 122, such that more or less denoising is applied based on whether a pixel is in a dark or light region of the input image 122. In an example, pixels in a dark background may not contain much information and may use more denoising, which may be applied by applying blurring in one or more portions of the input image 122 prior to denoising, and using the blurring as some form of mask for the denoising.

FIG. 3 is a diagram illustrating an example 300 of components that can be implemented in the device 102 of FIG. 1, in accordance with some examples of the present disclosure.

In the example 300, multiple versions of the synthetic noise 240 are applied to the input image 122 to generate multiple noise-added images 132. As illustrated, a first combiner 210A applies a first synthetic noise 240A to the input image 122 to generate a first noise-added image 132A in a first processing path 302A, a second combiner 210B applies a second synthetic noise 240B to the input image 122 to generate a second noise-added image 132B in a second processing path 302B, and an Nth combiner 210N applies an Nth synthetic noise 240N to the input image 122 to generate an Nth noise-added image 132N in an Nth processing path 302N (N is an integer >1). The different versions of synthetic noise 240A-240N have different sampled noise patterns and optionally have different intensities. For example, each of the versions of the synthetic noise 240 may sample the same Gaussian distribution (e.g., using the same mean and variance) to generate distinct noise patterns sampled from the same distribution.

Each of the multiple noise-added images 132 is denoised, generating multiple output images 142. For example, the first noise-added image 132A is processed at a first denoiser 140A to generate a first output image 142A, the second noise-added image 132B is processed at a second denoiser 140B to generate a second output image 142, and the Nth noise-added image 132N is processed at an Nth denoiser 140N to generate an Nth output image 142N.

The multiple output images 142A-142N are combined at a combiner 390 to generate an ensemble output image 392. For example, the combiner 390 may perform a pixel-wise average (arithmetic mean) of the N output images 142A-142N to generate the ensemble output image 392. To illustrate, each pixel of the ensemble output image 392 may have a value that is the average of the values of the corresponding pixel in each of the output images 142. The ensemble output image 392 can have less noise than one or more (or all) of the output images 142.

In some embodiments, combining the output images 142 can include performing a weighted average, and/or discarding outliers, of the pixel values of the output images 142. In an illustrative example, the distribution across each of the output images 142 of the pixel value for a particular pixel may have multiple modes, such as one or more peaks of the distribution, and the dominant mode may be selected and used for determining the value of that pixel for the ensemble output image 392 instead of averaging the pixel values for that pixel from all of the output images 142.

Although FIG. 3 illustrates N combiners 210A-210N and N denoisers 140A-140N arranged in N parallel processing paths 302A-302N, in some embodiments one or more of the combiners 210A-210N, one or more of the denoisers 140A-140N, or a combination thereof, may be shared across multiple processing paths 302. For example, in some embodiments, the device 102 includes a single combiner 210 and a single denoiser 140, and the processing illustrated in each of the processing paths 302 is performed sequentially (e.g., the operations of the first processing path 302A are performed first at the combiner 210 and the denoiser 140, the operations of the second processing path 302B are performed after the operations of the first processing path 302A, and so on). In some embodiments, one or more of the operations of the processing paths 302 are pipelined to improve throughput.

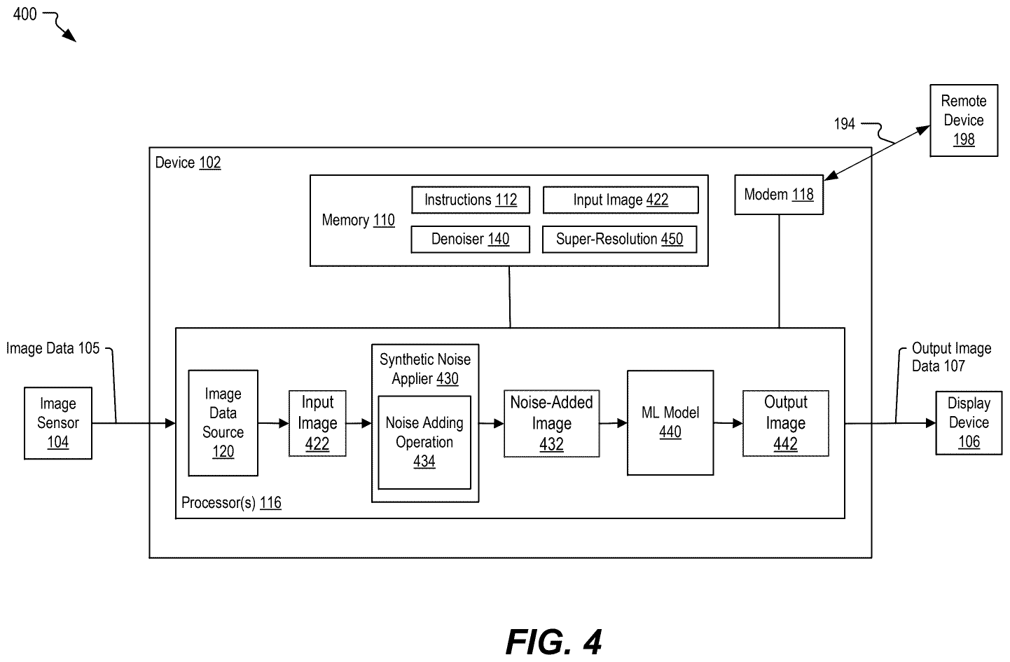

Generally, the above-disclosed techniques can provide enhanced denoising by causing the noise-added image(s) 132 to have a noise distribution that more closely matches the distribution that the denoiser 140 has been trained to recognize and compensate for, even though the noise of the original input image 122 may not be recognized as noise by the denoiser 140 due to having a different distribution than was used to train the denoiser 140. This concept can be extended to other applications, such as to improve super-resolution (SR) performance, as depicted in FIG. 4.

FIG. 4 is a block diagram illustrating an example of an implementation of a system 400 operable to perform image enhancement including super-resolution, in accordance with some examples of the present disclosure.

The system 400 includes the device 102 that is optionally coupled to the remote device 198, the image sensor 104, the display device 106, or a combination thereof. The device 102 includes the memory 110 and the one or more processors 116. The memory 110 is configured to store an input image 422 having a first size, and data (e.g., weights, biases, and/or other parameters) corresponding to a super-resolution model 450. Optionally, the memory 110 may also store data corresponding to one or more other ML models for image enhancement, such as the denoiser 140.

The one or more processors 116 include a synthetic noise applier 430 that is configured to receive the input image 422 from the image data source 120 and generate a noise-added version 432 of the input image 422. For example, the input image 422 may be obtained from the image sensor 104, retrieved from the memory 110, or obtained from one or more other sources such as the remote device 198 in a similar manner as described for the input image 122 of FIG. 1.

The one or more processors 116 are also configured to process the noise-added version 432 of the input image 422 using a trained ML model 440 to generate an output image 442. Generation of the noise-added version 432 of the input image 422 is based on a noise-adding operation 434 that was used during training of the ML model 440.

In a first illustrative example, the one or more processors 116 are configured to perform image enhancement according to a denoising mode in which the machine learning model 440 corresponds to the denoiser 140 and the synthetic noise applier 430 corresponds to the synthetic noise applier 130. In this first example, the noise-adding operation 434 includes application of synthetic noise to the input image 422 to generate the noise-added version 432 of the input image 422 (also referred to herein as the noise-added image 432), and the synthetic noise can correspond to the synthetic noise 240 that is generated based on the first distribution 242 associated with the training of the denoiser 140, as described with reference to FIG. 2. In this first example, the input image 422 can correspond to the input image 122, the noise-added image 432 can correspond to the noise-added image 132, and the output image 442 has less noise than the input image 422 and can correspond to the output image 142.

In a second illustrative example, the one or more processors 116 are configured to perform image enhancement according to a SR mode in which the machine learning model 440 corresponds to the SR model 450. The SR model 450 may correspond to a conventional SR model that is trained with synthetic pairs of low resolution (LR) and high resolution (HR) images, where the LR images used for training are obtained by processing the HR images with a blurring kernel (e.g., Gaussian), followed by downsampling (e.g., bicubic downsampling) the blurred HR images to generate LR images for training the SR model 450. However, because the SR model 450 is trained using LR training images that are based on downsampling a blurred HR image generated using the blurring kernel, the SR model 450 may exhibit unsatisfactory performance when processing real-world LR images (e.g., that are not generated using a blurring kernel).

In this second example, the synthetic noise applier 430 is configured to perform the noise-adding operation 434 to generate the noise-added image 432. The noise-adding operation 434 may include generation of an upsampled version of the input image 422 having a second size that is larger than a first size of the input image 422, and application of a synthetic blurring kernel to the upsampled version of the input image 422 to generate a blurred image. The synthetic blurring kernel corresponds to (e.g., matches) the blurring kernel used to generate LR images during the training of the super-resolution model 450. The noise-adding operation 434 also includes generation of the noise-added image 432 as a downsampled version of the blurred image.

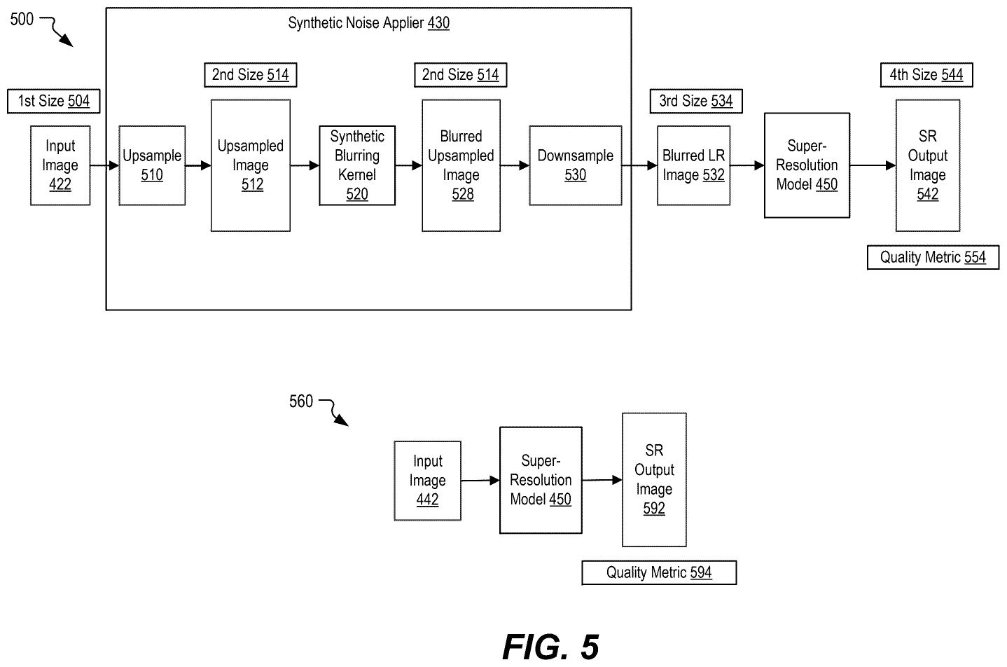

For example, as described further with reference to FIG. 5, the one or more processors 116 may perform upsampling (e.g., bicubic upsampling) of the input image 422, applying a synthetic blurring kernel (e.g., a Gaussian blurring kernel) that was used during the training of the SR model 450, and downsampling the blurred image back to the original size. In this manner, the synthetic noise applier 430 processes the input image 422 so that the resulting noise-added image 432 more closely resembles the distribution of LR training images of the SR model 450, so that the SR model 450 generates a higher quality SR output image 442 than would have resulted from the SR model 450 directly processing the input image 422.

Thus, using the synthetic noise applier 430 to generate the noise-added image 432 improves the performance of any off-the-shelf SR model that has been trained on a synthetic noise blurring kernel, enabling generation of higher-quality SR output images using real-world input images without retraining, finetuning, or introducing a complex SR kernel estimation procedure.

FIG. 5 depicts an example 500 of components and operations that may be implemented in the device 102 of FIG. 4, according to some examples of the present disclosure.

In the example 500, the synthetic noise applier 430 includes an upsample unit 510, a synthetic blurring kernel 520 that matches a blurring kernel used to generate low-resolution images during training of the super-resolution model 450, and a downsample unit 530. The upsample unit 510 is configured to upsample the input image 422, which has a first size 504, to generate an upsampled image 512 that has a second size 514 larger than the first size 504. The synthetic noise applier 430 is configured to apply the synthetic blurring kernel 520 to the upsampled image 512 to generate a blurred upsampled image 528 that also has the second size 514. The downsample unit 530 is configured to downsample the blurred upsampled image 528 to generate a blurred LR image 532. The blurred LR image 532 corresponds to the noise-added image 432 and is a downsampled image that has a third size 534. The third size 534 can match the first size 504 or can be another size that matches an input of the SR model 450.

The blurred LR image 532 is input to the SR model 450, which processes the blurred LR image 532 to generate a SR output image 542 that has a fourth size 544. The SR output image corresponds to the output image 442. In some examples, the fourth size 544 matches the second size 514.

The SR output image 542 has a higher quality than would be achieved by the SR model 450 processing the input image 422, which may be quantified via a first quality metric 554 (e.g., SNR, PSNR, or MSE). To illustrate, a second example 560 depicts a comparison in which the input image 422 is processed by the SR model 450 to generate an SR output image 592 that has a lower quality than the SR output image 542. As illustrated, the quality of the SR output image 592 may be quantified via a second quality metric 594, and the second quality metric 594 may have a value indicating a lower quality than is indicated by the value of the first quality metric 554.

FIG. 6 is a block diagram illustrating an implementation 600 of the device 102 as an integrated circuit 602 for performing image enhancement. The integrated circuit 602 includes the one or more processors 116, which include the synthetic noise applier 430 and the ML model 440 (e.g., the synthetic noise applier 130 and the denoiser 140, respectively, of FIG. 1). For example, the synthetic noise applier 430 and the ML model 440 can correspond to the synthetic noise applier 130 and the denoiser 140, respectively, of FIG. 1, and may include one or more of the components of FIG. 2 or FIG. 3. In another example, the synthetic noise applier 430 and the ML model 440 can correspond to the synthetic noise applier 130 and the SR model 450, respectively, of FIG. 4 or FIG. 5. The integrated circuit 602 also includes a signal input 604, such as a bus interface, to enable image data 605, such as the image data 105, the input image 122, or the input image 422 to be received. The integrated circuit 602 includes a signal output 606, such as a bus interface, to enable outputting enhanced image data 607, such as the output image data 107, the output image 142, the ensemble output image 392, the output image 442, or the SR output image 542. Optionally, the integrated circuit 602 also includes the memory 110, the image sensor 104, the image data source 120, the modem 118, the combiner 390, a display engine, etc. The integrated circuit 602 enables implementation of image enhancement as a component in a system that performs image processing, such as depicted in FIG. 1.

FIG. 7 depicts an implementation 700 in which the device 102 includes a mobile device 702, such as a phone or tablet, as illustrative, non-limiting examples. The mobile device 702 includes a display screen 704 and a camera 712 (e.g., the image sensor 104). The synthetic noise applier 430 and the ML model 440 are integrated in the mobile device 702, such as in the integrated circuit 602, which is illustrated using dashed lines to indicate internal components that are not generally visible to a user of the mobile device 702. In a particular example, the synthetic noise applier 430 and the ML model 440 operate to perform image enhancement, such as denoising as described with reference to FIGS. 1-4, super-resolution as described with reference to FIGS. 4-5, or a combination thereof. For example, the mobile device 702 may generate the image data 105 from the camera 712, process the image data 105 using the synthetic noise applier 430 and the ML model 440, and display the resulting output image data 107 at the display screen 704 and/or transmit the resulting output image data 107 to another device, such as the remote device 198.

FIG. 8 depicts an implementation 800 in which the device 102 includes a portable electronic device that corresponds to a camera device 802. The camera device 802 includes an image sensor 812, such as the image sensor 104. The synthetic noise applier 430 and the ML model 440 are integrated in the mobile device 702, such as in the integrated circuit 602. In a particular example, the synthetic noise applier 430 and the ML model 440 operate to perform image enhancement, such as denoising as described with reference to FIGS. 1-4, super-resolution as described with reference to FIGS. 4-5, or a combination thereof. For example, camera device 802 may generate the image data 105 from the image sensor 812, process the image data 105 using the synthetic noise applier 430 and the ML model 440, and display the resulting output image data 107 at a display screen of the camera device 802, store the output image data 107 at a memory of the camera device 802, and/or transmit the output image data 107 to another device, such as the remote device 198.

FIG. 9 depicts an implementation 900 of a wearable electronic device 902, illustrated as a “smart watch.” In a particular aspect, the wearable electronic device 902 includes the device 102. The wearable electronic device 902 includes a display screen 904 and a camera 912 (e.g., the image sensor 104). The synthetic noise applier 430 and the ML model 440 are integrated in the wearable electronic device 902, such as in the integrated circuit 602. In a particular example, the wearable electronic device 902 includes a haptic device that provides a haptic notification (e.g., vibrates) associated with display of image or video data that has been captured by the camera 912, processed by the synthetic noise applier 430 and the ML model 440, and displayed via the display screen 904. For example, the haptic notification can cause a user to look at the wearable electronic device 902 to watch video playback.

FIG. 10 depicts an implementation 1000 in which the device 102 includes a portable electronic device that corresponds to an extended reality device, such as augmented reality or mixed reality glasses 1002. The glasses 1002 include a holographic projection unit 1004 configured to project visual data onto a surface of a lens 1006 or to reflect the visual data off of a surface of the lens 1006 and onto the wearer's retina. The glasses 1002 include a camera 1012, such as the image sensor 104. The synthetic noise applier 430 and the ML model 440 are integrated in the glasses 1002, such as in the integrated circuit 602. In a particular example, the synthetic noise applier 430 and the ML model 440 operate to perform image enhancement, such as denoising as described with reference to FIGS. 1-4, super-resolution as described with reference to FIGS. 4-5, or a combination thereof. For example, the image data 105 may be received from the camera 1012, processed using the synthetic noise applier 430 and the ML model 440, and the resulting output image data 107 displayed via a projection onto the surface of the lens 1006 to enable display of images and/or video associated with augmented reality, mixed reality, or virtual reality scenes to the user while the glasses 1002 are worn.

FIG. 11 depicts an implementation 1100 in which the device 102 includes a portable electronic device that corresponds to a virtual reality, augmented reality, or mixed reality headset 1102. The headset 1102 includes a camera 1112, such as the image sensor 104, and a visual display device 1104. The synthetic noise applier 430 and the ML model 440 are integrated in the headset 1102, such as in the integrated circuit 602. In a particular example, the synthetic noise applier 430 and the ML model 440 operate to perform image enhancement, such as denoising as described with reference to FIGS. 1-4, super-resolution as described with reference to FIGS. 4-5, or a combination thereof. For example, the image data 105 may be received from the camera 1112, processed using the synthetic noise applier 430 and the ML model 440, and the resulting output image data 107 displayed at the visual display device 1104 to enable display of images and/or video associated with augmented reality, mixed reality, or virtual reality scenes to the user while the headset 1102 is worn.

FIG. 12 is an implementation 1200 of a wireless speaker and voice activated device 1202. In a particular aspect, the wireless speaker and voice activated device 1202 includes the device 102. The wireless speaker and voice activated device 1202 can have wireless network connectivity and is configured to execute an assistant operation. The one or more processors 116 are included in the wireless speaker and voice activated device 1202 and include the synthetic noise applier 430 and the ML model 440.

The wireless speaker and voice activated device 1202 includes a camera 1212, such as the image sensor 104, and a display device 1220. In a particular example, the synthetic noise applier 430 and the ML model 440 operate to perform image enhancement, such as denoising as described with reference to FIGS. 1-4, super-resolution as described with reference to FIGS. 4-5, or a combination thereof. For example, the image data 105 may be received from the camera 1212 and processed using the synthetic noise applier 430 and the ML model 440, and the resulting output image data 107 may be displayed at the display device 1220 to enable display of images and/or video captured by the camera 1212, and/or transmitted to a remote device for playback at the remote device.

In a particular aspect, the wireless speaker and voice activated device 1202 includes one or more microphones 1210 and one or more speakers 1204. During operation, in response to receiving a verbal command via one or more microphones 1210, the wireless speaker and voice activated device 1202 can execute assistant operations, such as via execution of a voice activation system (e.g., an integrated assistant application). The assistant operations can include adjusting a temperature, activating the camera 1212 to capture video content and playing the captured video content at the display device 1220, etc. For example, the assistant operations are performed responsive to receiving a command after a keyword or key phrase (e.g., “hello assistant”).

FIG. 13 depicts an implementation 1300 in which the device 102 corresponds to or is integrated within a vehicle 1302, illustrated as a manned or unmanned aerial device (e.g., a package delivery drone). The synthetic noise applier 430 and the ML model 440 are integrated in the vehicle 1302, such as in the integrated circuit 602. The vehicle 1302 also includes a display device 1304 configured to display an output based on processing image data at the synthetic noise applier 430 and the ML model 440, such as the output image data 107.

In some implementations, the vehicle 1302 is manned (e.g., carries a pilot, one or more passengers, or both), the display device 1304 is internal to a cabin of the vehicle 1302, and the image enhancement using the synthetic noise applier 430 and the ML model 440 is performed during video capture via a camera 1312, such as for playback to a pilot or a passenger of the vehicle 1302. In another implementation, the vehicle 1302 is unmanned, the display device 1304 and the camera 1312 are mounted to an external surface of the vehicle 1302, and the image enhancement using the synthetic noise applier 430 and the ML model 440 is performed during video playback to one or more viewers external to the vehicle 1302. For example, the vehicle 1302 may move (e.g., circle an outdoor audience during a concert) while playing out video such as steaming video of the concert stage captured via the camera 1312, and the one or more processors 116 (e.g., including the synthetic noise applier 430 and the ML model 440) may perform image enhancement to generate the video from the scene captured by the camera 1312.

FIG. 14 depicts an implementation 1400 in which the device 102 corresponds to, or is integrated within, a vehicle 1402, illustrated as a car. The synthetic noise applier 430 and the ML model 440 are integrated in the vehicle 1402, such as in the integrated circuit 602. In a particular example, the synthetic noise applier 430 and the ML model 440 operate to perform image enhancement, such as denoising as described with reference to FIGS. 1-4, super-resolution as described with reference to FIGS. 4-5, or a combination thereof. For example, the vehicle 1402 may generate the image data 105 from a camera 1412, process the image data 105 using the synthetic noise applier 430 and the ML model 440, and display the resulting output image data 107 at a display screen 1420, store the output image data 107 at a memory of the vehicle 1402, and/or transmit the output image data 107 to another device, such as the remote device 198. In a particular embodiment, the camera 1412 can be mounted to enable an operator of the vehicle 1402 to observe one or more other passengers of the vehicle 1402, such as to monitor children in a rear seat of the vehicle 1402. Additionally, or alternatively, one or more cameras 1412 can correspond to forward-facing camera and/or rear-facing cameras that capture fields of view external to the vehicle 1402 in conjunction with autonomous or driver-assisted operation of the vehicle 1402.

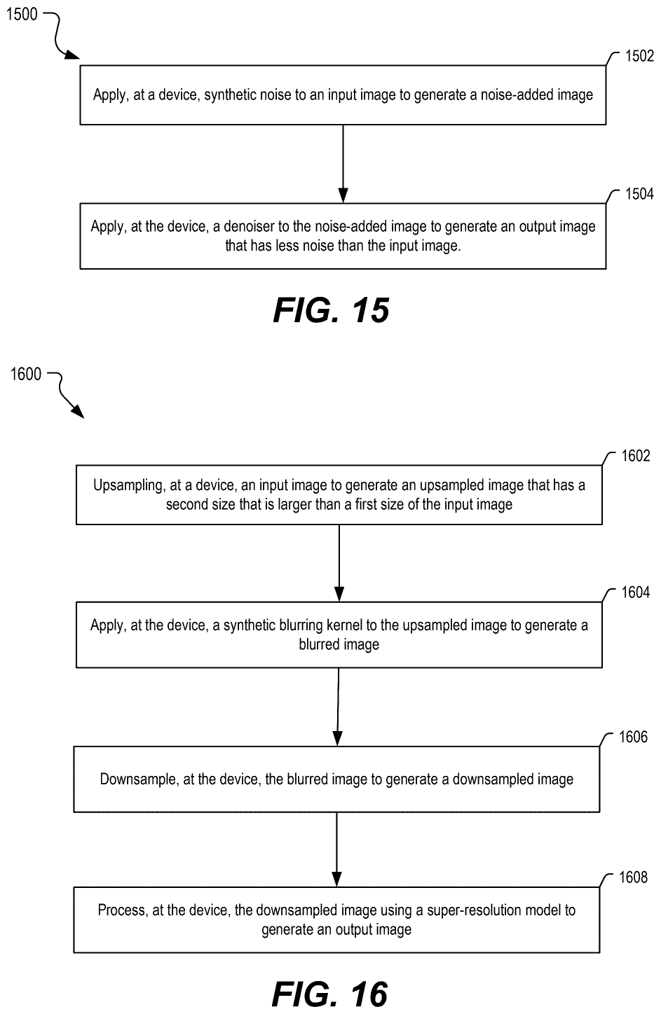

FIG. 15 illustrates an example of a method 1500 of image enhancement. One or more operations of the method 1500 may be performed by at least one of the device 102, the one or more processors 116, the system 100 of FIG. 1, or the system 400 of FIG. 4, as an illustrative, non-limiting example.

The method 1500 includes, at block 1502, applying, at a device, synthetic noise to an input image to generate a noise-added image. For example, the synthetic noise applier 130 applies synthetic noise (e.g., the synthetic noise 240) to the input image 122 to generate the noise-added image 132. The method 1500 may include generating the synthetic noise based on a first distribution associated with training of the denoiser, such as described for the synthetic noise 240 generated by the synthetic noise generator 212.

The method 1500 includes, at block 1504, applying, at the device, a denoiser to the noise-added image to generate an output image that has less noise than the input image. According to an aspect, the denoiser is a blind denoiser. For example, the denoiser 140 is applied to the noise-added image 132 to generate the output image 142.

By applying the synthetic noise to the input image and processing the resulting noise-added image at the denoiser, the resulting output image can have less noise as compared to processing the input image at the denoiser.

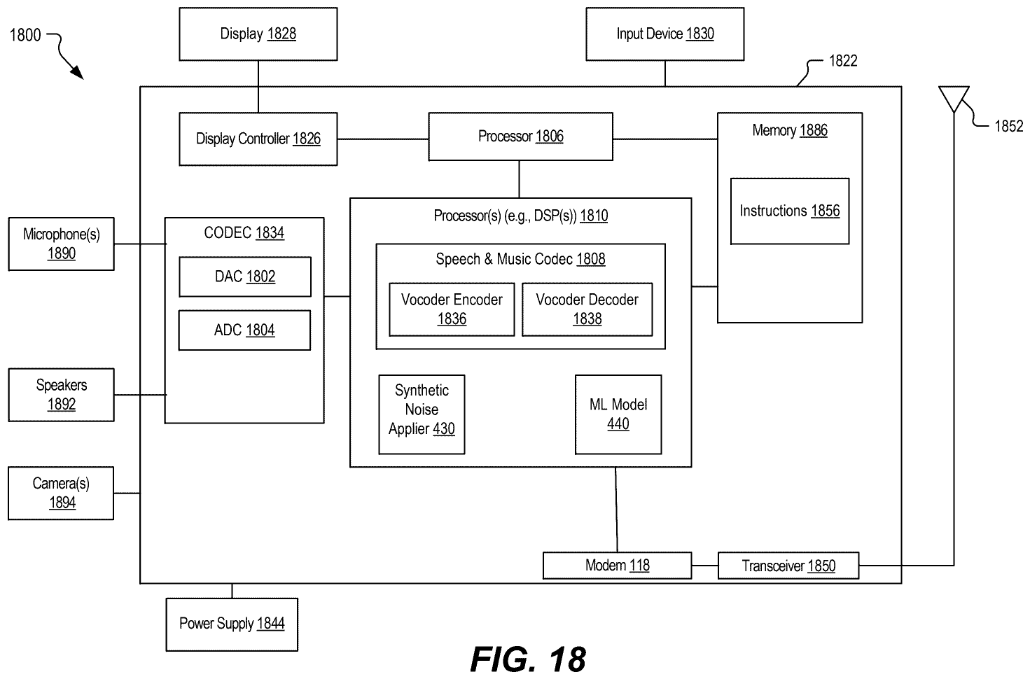

The method 1500 of FIG. 15 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1500 of FIG. 15 may be performed by a processor that executes instructions, such as described with reference to FIG. 18.

FIG. 16 illustrates an example of a method 1600 of image enhancement. One or more operations of the method 1600 may be performed by at least one of the device 102, the one or more processors 116, or the system 400 of FIG. 4, as an illustrative, non-limiting example.

The method 1600 includes, at block 1602, upsampling, at a device, an input image to generate an upsampled image that has a second size that is larger than a first size of the input image. For example, the input image 422 is upsampled by the upsample unit 510 to generate the upsampled image 512 that has the second size 514 that is larger than the first size 504 of the input image 422.

The method 1600 includes, at block 1604, applying, at the device, a synthetic blurring kernel to the upsampled image to generate a blurred image. For example, the synthetic blurring kernel 520 is applied, by the synthetic noise applier 430, to the upsampled image 512 to generate the blurred upsampled image 528. According to an aspect, the synthetic blurring kernel 520 matches a blurring kernel used to generate low-resolution images during training of the super-resolution model 450. For example, the synthetic blurring kernel 520 may match the blurring kernel used to generate low-resolution images during training of the super-resolution model 450.

The method 1600 includes, at block 1606, downsampling, at the device, the blurred image to generate a downsampled image. For example, the blurred upsampled image 528 is downsampled by the downsample unit 530 to generate the blurred LR image 532.

The method 1600 includes, at block 1608, processing, at the device, the downsampled image using a super-resolution model to generate an output image. For example, the blurred LR image 532 is processed using the super-resolution model 450 to generate the SR output image 542.

By applying the synthetic blurring kernel to the upsampled version of the input image and downsampling the blurred version for processing at the super-resolution model, the resulting output image can have greater similarity to the training images used to train the super-resolution model. As a result, the output image can have a higher quality as compared to processing the input image at the super-resolution model.

The method 1600 of FIG. 16 may be implemented by an FPGA device, an ASIC, a processing unit such as a CPU, a DSP, a controller, another hardware device, firmware device, or any combination thereof. As an example, the method 1600 of FIG. 16 may be performed by a processor that executes instructions, such as described with reference to FIG. 18.

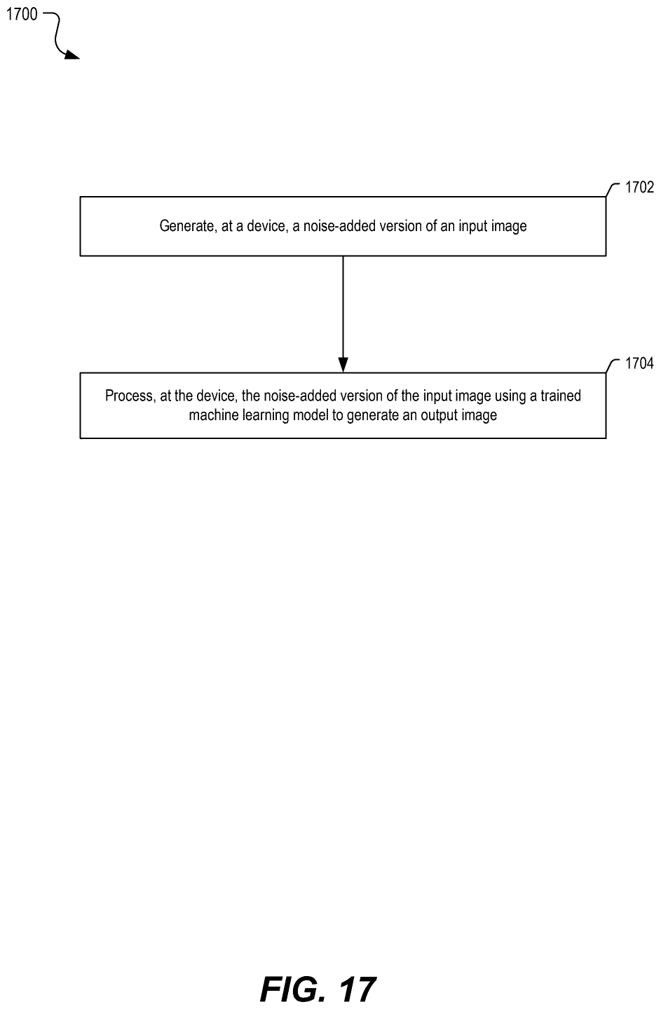

FIG. 17 illustrates an example of a method 1700 of image enhancement. One or more operations of the method 1700 may be performed by at least one of the device 102, the one or more processors 116, or the system 400 of FIG. 4, as an illustrative, non-limiting example.

The method 1700 includes, at block 1702, generating, at a device, a noise-added version of an input image. For example, the synthetic noise applier 430 processes the input image 422 to generate the noise-added image 432. In a denoising embodiment, generating the noise-added version of the input image can include applying synthetic noise to the input image to generate a noise-added image, such as the synthetic noise 240 that is applied to the input image 422. In a super-resolution embodiment, generating the noise-added version of the input image can include generating an upsampled version of the input image (e.g., the upsampled image 512) having a second size larger than a first size of the input image, applying a synthetic blurring kernel (e.g., the synthetic blurring kernel 520) to the upsampled version of the input image to generate a blurred image (e.g., the blurred upsampled image 528), and generating a downsampled version of the blurred image (e.g., the blurred LR image 532).

The method 1700 includes, at block 1704, processing, at the device, the noise-added version of the input image using a trained machine learning model to generate an output image. For example, the noise-added image 432 is processed using the machine learning model 440 to generate the output image 442. In a denoising embodiment, the machine learning model can correspond to a denoiser, such as the denoiser 140. In a super-resolution embodiment, the machine learning model can correspond to a super-resolution model, such as the SR model 450.

Generation of the noise-added version of the input image is based on a noise-adding operation, such as the noise-adding operation 434, that was used during training of the machine learning model. For example, in a denoising embodiment, the noise-adding operation may include generating synthetic noise (e.g., the synthetic noise 240) based on a first distribution (e.g., the first distribution 242) associated with training of a denoiser (e.g., the denoiser 140). As another example, in a super-resolution embodiment, the noise-adding operation may include of a synthetic blurring kernel (e.g., the synthetic blurring kernel 520) that matches a blurring kernel used to generate low-resolution images during training of a super-resolution model (e.g., the super-resolution model 450).

By generating a noise-added version of an input image based on a noise-adding operation that was used during training of the machine learning model, the noise-added version can have greater similarity to the training images used to train the super-resolution model. Processing such noise-added versions of input images at the trained machine learning model results in higher-quality output images than would otherwise be attainable by processing the input images at the super-resolution model.

The method 1700 of FIG. 17 may be implemented by an FPGA device, an ASIC, a processing unit such as a CPU, a DSP, a controller, another hardware device, firmware device, or any combination thereof. As an example, the method 1700 of FIG. 17 may be performed by a processor that executes instructions, such as described with reference to FIG. 18.

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102 of FIG. 1 or FIG. 4. In an illustrative implementation, the device 1800 may perform one or more operations described with reference to FIGS. 1-17.

In a particular implementation, the device 1800 includes a processor 1806 (e.g., a CPU). The device 1800 may include one or more additional processors 1810 (e.g., one or more DSPs). In a particular implementation, the one or more processors 116 of FIG. 1 or FIG. 4 correspond to the processor 1806, the processors 1810, or a combination thereof. For example, the processors 1810 may include the synthetic noise applier 430 and the ML model 440. For example, the synthetic noise applier 430 and the ML model 440 can correspond to the synthetic noise applier 130 and the denoiser 140, respectively, of FIG. 1, and may include one or more of the components of FIG. 2 or FIG. 3. In another example, the synthetic noise applier 430 and the ML model 440 can correspond to the synthetic noise applier 130 and the SR model 450, respectively, of FIG. 4 or FIG. 5. The processors 1810 may also include a speech and music coder-decoder (CODEC) 1808. The speech and music CODEC 1808 may include a voice coder (“vocoder”) encoder 1836, a vocoder decoder 1838, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, CPUs, digital signal processors DSPs, neural processing units (NPUs), graphics processing units (GPUs), FPGAs, microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1800 may include a memory 1886 and a CODEC 1834. The memory 1886 may include instructions 1856 that are executable by the one or more additional processors 1810 (or the processor 1806) to implement the functionality described with reference to the processor 116. In a particular example, the memory 1886 corresponds to the memory 110 and the instructions 1856 correspond to the instructions 112 of FIG. 1 or FIG. 4. The device 1800 may include the modem 118 coupled, via a transceiver 1850, to an antenna 1852. The device 1800 may also include one or more cameras 1894, one or more of which may correspond to the image sensor 104.

The device 1800 may include a display 1828, such as the display device 106, coupled to a display controller 1826. One or more speakers 1892, one or more microphones 1890, or a combination thereof, may be coupled to the CODEC 1834. The CODEC 1834 may include a digital-to-analog converter (DAC) 1802 and an analog-to-digital converter (ADC) 1804. In a particular implementation, the CODEC 1834 may receive analog signals from the microphones 1890, convert the analog signals to digital signals using the analog-to-digital converter 1804, and send the digital signals to the speech and music codec 1808. In a particular implementation, the speech and music codec 1808 may provide digital signals to the CODEC 1834. The CODEC 1834 may convert the digital signals to analog signals using the digital-to-analog converter 1802 and may provide the analog signals to the speakers 1892.

In a particular implementation, the device 1800 may be included in a system-in-package or system-on-chip device 1822. In a particular implementation, the memory 1886, the processor 1806, the processors 1810, the display controller 1826, the CODEC 1834, and the modem 118 are included in a system-in-package or system-on-chip device 1822. In a particular implementation, an input device 1830 (e.g., a keyboard, a touchscreen, or a pointing device) and a power supply 1844 are coupled to the system-in-package or system-on-chip device 1822. Moreover, in a particular implementation, as illustrated in FIG. 18, the cameras 1894, the display 1828, the input device 1830, the speakers 1892, the microphones 1890, the antenna 1852, and the power supply 1844 are external to the system-in-package or system-on-chip device 1822. In a particular implementation, each of the cameras 1894, the display 1828, the input device 1830, the speakers 1892, the microphones 1890, the antenna 1852, and the power supply 1844 may be coupled to a component of the system-in-package or system-on-chip device 1822, such as an interface or a controller.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a vehicle, a computing device, a communication device, an internet-of-things (IoT) device, a virtual reality (VR) device, a base station, a mobile device, or any combination thereof.

In conjunction with the described techniques, a first apparatus includes means for applying synthetic noise to an input image to generate a noise-added image. In an example, the means for applying synthetic noise to an input image to generate a noise-added image can include the synthetic noise applier 130, the one or more processors 116, the device 102, the system 100, the combiner 210, the synthetic noise generator 212, the synthetic noise applier 430, the system 400, one or more other circuits or devices to apply synthetic noise to an input image to generate a noise-added image, or a combination thereof.

The first apparatus also includes means for applying a denoiser to the noise-added image to generate an output image that has less noise than the input image. In an example, the means for applying a denoiser to the noise-added image to generate an output image that has less noise than the input image can include the denoiser 140, the one or more processors 116, the device 102, the system 100, the system 400, the ML model 440 executed by the one or more processors 116, one or more other circuits or devices to apply a denoiser to the noise-added image to generate an output image that has less noise than the input image, or a combination thereof.

In conjunction with the described techniques, a second apparatus includes means for upsampling an input image to generate an upsampled image that has a second size that is larger than a first size of the input image. In an example, the means for upsampling an input image to generate an upsampled image that has a second size that is larger than a first size of the input image can include the one or more processors 116, the device 102, the synthetic noise applier 430, the system 400, the upsample unit 510, one or more other circuits or devices to upsample an input image to generate an upsampled image that has a second size that is larger than a first size of the input image, or a combination thereof.

The second apparatus includes means for applying a synthetic blurring kernel to the upsampled image to generate a blurred image. In an example, the means for applying a synthetic blurring kernel to the upsampled image to generate a blurred image can include the one or more processors 116, the device 102, the synthetic noise applier 430, the system 400, the synthetic blurring kernel 520, one or more other circuits or devices to apply a synthetic blurring kernel to the upsampled image to generate a blurred image, or a combination thereof.

The second apparatus includes means for downsampling the blurred image to generate a downsampled image. In an example, the means for downsampling the blurred image to generate a downsampled image can include the one or more processors 116, the device 102, the synthetic noise applier 430, the system 400, the downsample unit 530, one or more other circuits or devices to downsample the blurred image to generate a downsampled image, or a combination thereof.

The second apparatus also includes means for processing the downsampled image using a super-resolution model to generate an output image. In an example, the means for processing the downsampled image using a super-resolution model to generate an output image can include the one or more processors 116, the device 102, the system 400, the ML model 440 executed by the one or more processors 116, the super-resolution model 450 executed by the one or more processors 116, one or more other circuits or devices to process the downsampled image using a super-resolution model to generate an output image, or a combination thereof.

In conjunction with the described techniques, a third apparatus includes means for generating a noise-added version of an input image. In an example, the means for generating a noise-added version of an input image can include the synthetic noise applier 130, the one or more processors 116, the device 102, the system 100, the combiner 210, the synthetic noise generator 212, the synthetic noise applier 430, the system 400, the upsample unit 510, the synthetic blurring kernel 520, the downsample unit 530, one or more other circuits or devices to generate a noise-added version of an input image, or a combination thereof.

The third apparatus also includes means for processing the noise-added version of the input image using a trained machine learning model to generate an output image, wherein generation of the noise-added version of the input image is based on a noise-adding operation that was used during training of the machine learning model. In an example, the means for processing the noise-added version of the input image using a trained machine learning model to generate an output image can include the denoiser 140, the one or more processors 116, the device 102, the system 100, the system 400, the ML model 440 executed by the one or more processors 116, the super-resolution model 450 executed by the one or more processors 116, one or more other circuits or devices to process the noise-added version of the input image using a trained machine learning model to generate an output image, or a combination thereof.

In some implementations, a non-transitory computer-readable medium (e.g., a computer-readable storage device, such as the memory 110) includes instructions (e.g., the instructions 112) that, when executed by one or more processors (e.g., the one or more processors 116), cause the one or more processors to perform operations corresponding to at least a portion of any of the techniques described with reference to FIGS. 1-14, any of the methods of FIGS. 15-17, or any combination thereof. In a first example, the instructions, when executed by the one or more processors, cause the one or more processors to apply synthetic noise (e.g., the synthetic noise 240) to an input image (e.g., the input image 122) to generate a noise-added image (e.g., the noise-added image 132). The instructions, when executed by the one or more processors, also cause the one or more processors to apply a denoiser (e.g., the denoiser 140) to the noise-added image to generate an output image (e.g., the output image 142) that has less noise than the input image.

In a second example, the instructions, when executed by the one or more processors, cause the one or more processors to upsample an input image (e.g., the input image 422) to generate an upsampled image (e.g., the upsampled image 512) that has a second size (e.g., the second size 514) that is larger than a first size (e.g., the first size 504) of the input image. The instructions, when executed by the one or more processors, cause the one or more processors to apply a synthetic blurring kernel (e.g., the synthetic blurring kernel 520) to the upsampled image to generate a blurred image (e.g., the blurred upsampled image 528). The instructions, when executed by the one or more processors, cause the one or more processors to downsample the blurred image to generate a downsampled image (e.g., the blurred LR image 532). The instructions, when executed by the one or more processors, also cause the one or more processors to process the downsampled image using a super-resolution model (e.g., the super-resolution model 450) to generate an output image (e.g., the SR output image 542).

In a third example, the instructions, when executed by the one or more processors, cause the one or more processors to generate a noise-added version (e.g., the noise-added version 432) of an input image (e.g., the input image 422). The instructions, when executed by the one or more processors, also cause the one or more processors to process the noise-added version of the input image using a trained machine learning model (e.g., the ML model 440) to generate an output image (e.g., the output image 442), wherein generation of the noise-added version of the input image is based on a noise-adding operation (e.g., the noise-adding operation 434) that was used during training of the machine learning model.

Particular aspects of the disclosure are described below in the following sets of interrelated Examples:

According to Example 1, a device includes a memory configured to store an input image; and one or more processors configured to apply synthetic noise to the input image to generate a noise-added image; and apply a denoiser to the noise-added image to generate an output image that has less noise than the input image.

Example 2 includes the device of Example 1, wherein the denoiser is a blind denoiser.

Example 3 includes the device of Example 1 or Example 2, wherein the input image includes a first amount of noise, and wherein the output image includes a second amount of noise that is less than the first amount.

Example 4 includes the device of any of Examples 1 to 3, wherein the one or more processors are further configured to generate the synthetic noise.

Example 5 includes the device of Example 4, wherein the synthetic noise is generated based on a first distribution associated with training of the denoiser.

Example 6 includes the device of Example 5, wherein noise in the input image is associated with a second distribution that is different from the first distribution and wherein the denoiser, during removal of the synthetic noise from the noise-added image, also removes at least some of the noise of the input image.

Example 7 includes the device of any of Examples 1 to 6, wherein the one or more processors are configured to apply multiple versions of synthetic noise to the input image to generate multiple noise-added images; denoise each of the multiple noise-added images to generate multiple output images; and combine the multiple output images to generate an ensemble output image.

Example 8 includes the device of any of Examples 1 to 7 and further includes a display device configured to display the output image.

Example 9 includes the device of any of Examples 1 to 8 and further includes an image sensor configured to generate image data corresponding to the input image.

Example 10 includes the device of any of Examples 1 to 9 and further includes a modem coupled to the one or more processors, the modem configured to receive the input image from a second device.

Example 11 includes the device of any of Examples 1 to 10, wherein the one or more processors are integrated in a headset device that includes a display, and wherein the headset device is configured, when worn by a user, to display the output image at the display.

Example 12 includes the device of any of Examples 1 to 10, wherein the one or more processors are integrated in at least one of a mobile phone, a tablet computer device, a wearable electronic device, or a camera device.

Example 13 includes the device of any of Examples 1 to 10, wherein the one or more processors are integrated in a vehicle, the vehicle further including a display device configured to display the output image.

Example 14 includes the device of any of Examples 1 to 13, wherein the one or more processors are included in an integrated circuit.

According to Example 15, a method includes applying, at a device, synthetic noise to an input image to generate a noise-added image; and applying, at the device, a denoiser to the noise-added image to generate an output image that has less noise than the input image.

Example 16 includes the method of Example 15, wherein the denoiser is a blind denoiser.

Example 17 includes the method of Example 15 or Example 16, wherein the input image includes a first amount of noise, and wherein the output image includes a second amount of noise that is less than the first amount.

Example 18 includes the method of any of Examples 15 to 17 and further includes generating the synthetic noise.

Example 19 includes the method of any of Examples 15 to 17 and further includes generating the synthetic noise based on a first distribution associated with training of the denoiser.

Example 20 includes the method of Example 19, wherein noise in the input image is associated with a second distribution that is different from the first distribution.

Example 21 includes the method of Examples 20 and further includes, during removal of the synthetic noise from the noise-added image, also removing at least some of the noise of the input image.

Example 22 includes the method of any of Examples 15 to 21, and further includes applying one or more additional versions of the synthetic noise to the input image to generate one or more additional noise-added images; denoising each of the one or more additional noise-added images to generate one or more additional output images; and combining the output image and the one or more additional output images to generate an ensemble output image.

According to Example 23, an apparatus includes means for applying synthetic noise to an input image to generate a noise-added image; and means for applying a denoiser to the noise-added image to generate an output image that has less noise than the input image.

Example 24 includes the apparatus of Example 23, wherein the denoiser is a blind denoiser.

Example 25 includes the apparatus of Example 23 or Example 24, wherein the input image includes a first amount of noise, and wherein the output image includes a second amount of noise that is less than the first amount.

Example 26 includes the apparatus of any of Examples 23 to 25 and further includes means for generating the synthetic noise.

Example 27 includes the apparatus of any of Examples 23 to 26, wherein the synthetic noise is based on a first distribution associated with training of the denoiser.

Example 28 includes the apparatus of Example 27, wherein noise in the input image is associated with a second distribution that is different from the first distribution.

Example 29 includes the apparatus of Examples 28, wherein, during removal of the synthetic noise from the noise-added image, at least some of the noise of the input image is also removed.

Example 30 includes the apparatus of any of Examples 23 to 29, and further includes means for applying one or more additional versions of the synthetic noise to the input image to generate one or more additional noise-added images; means for denoising each of the one or more additional noise-added images to generate one or more additional output images; and means for combining the output image and the one or more additional output images to generate an ensemble output image.

According to Example 31, a non-transitory computer-readable medium comprising instructions that, when executed by one or more processors, cause the one or more processors to apply synthetic noise to an input image to generate a noise-added image; and apply a denoiser to the noise-added image to generate an output image that has less noise than the input image.

Example 32 includes the non-transitory computer-readable medium of Example 31, wherein the denoiser is a blind denoiser.

Example 33 includes the non-transitory computer-readable medium of Example 31 or Example 32, wherein the input image includes a first amount of noise, and wherein the output image includes a second amount of noise that is less than the first amount.

Example 34 includes the non-transitory computer-readable medium of any of Examples 31 to 33, wherein the instructions, when executed by the one or more processors, further cause the one or more processors to generate the synthetic noise.

Example 35 includes the non-transitory computer-readable medium of any of Examples 31 to 33, wherein the instructions, when executed by the one or more processors, further cause the one or more processors to generate the synthetic noise based on a first distribution associated with training of the denoiser.

Example 36 includes the non-transitory computer-readable medium of Example 35, wherein noise in the input image is associated with a second distribution that is different from the first distribution.

Example 37 includes the non-transitory computer-readable medium of any of Examples 31 to 36, wherein the instructions, when executed by the one or more processors, further cause the one or more processors to, during removal of the synthetic noise from the noise-added image, also remove at least some of the noise of the input image.

Example 38 includes the non-transitory computer-readable medium of any of Examples 31 to 37, wherein the instructions, when executed by the one or more processors, further cause the one or more processors to apply one or more additional versions of the synthetic noise to the input image to generate one or more additional noise-added images; denoise each of the one or more additional noise-added images to generate one or more additional output images; and combine the output image and the one or more additional output images to generate an ensemble output image.

According to Example 39, a device includes a memory configured to store an input image having a first size; and one or more processors configured to upsample the input image to generate an upsampled image that has a second size larger than the first size; apply a synthetic blurring kernel to the upsampled image to generate a blurred image; downsample the blurred image to generate a downsampled image; and process the downsampled image using a super-resolution model to generate an output image.

Example 40 includes the device of Example 39, wherein the synthetic blurring kernel matches a blurring kernel used to generate low-resolution images during training of the super-resolution model.

Example 41 includes the device of Example 39 or Example 40, and further includes a display device configured to display the output image.

Example 42 includes the device of any of Examples 39 to 41, and further includes an image sensor configured to generate image data corresponding to the input image.

Example 43 includes the device of any of Examples 39 to 42, and further includes a modem coupled to the one or more processors, the modem configured to receive the input image from a second device.

Example 44 includes the device of any of Examples 39 to 43, wherein the one or more processors are integrated in a headset device that includes a display, and wherein the headset device is configured, when worn by a user, to display the output image at the display.

Example 45 includes the device of any of Examples 39 to 43, wherein the one or more processors are integrated in at least one of a mobile phone, a tablet computer device, a wearable electronic device, or a camera device.

Example 46 includes the device of any of Examples 39 to 43, wherein the one or more processors are integrated in a vehicle, the vehicle further including a display device configured to display the output image.

Example 47 includes the device of any of Examples 39 to 46, wherein the one or more processors are included in an integrated circuit.

According to Example 48, a method includes upsampling, at a device, an input image to generate an upsampled image that has a second size that is larger than a first size of the input image; applying, at the device, a synthetic blurring kernel to the upsampled image to generate a blurred image; downsampling, at the device, the blurred image to generate a downsampled image; and processing, at the device, the downsampled image using a super-resolution model to generate an output image.

Example 49 includes the method of Example 48, wherein the synthetic blurring kernel matches a blurring kernel used to generate low-resolution images during training of the super-resolution model.

According to Example 50, an apparatus includes means for upsampling an input image to generate an upsampled image that has a second size that is larger than a first size of the input image; means for applying a synthetic blurring kernel to the upsampled image to generate a blurred image; means for downsampling the blurred image to generate a downsampled image; and means for processing the downsampled image using a super-resolution model to generate an output image.

Example 51 includes the apparatus of Example 50, wherein the synthetic blurring kernel matches a blurring kernel used to generate low-resolution images during training of the super-resolution model.

According to Example 52, a non-transitory computer-readable medium comprising instructions that, when executed by one or more processors, cause the one or more processors to upsample an input image to generate an upsampled image that has a second size that is larger than a first size of the input image; apply a synthetic blurring kernel to the upsampled image to generate a blurred image; downsample the blurred image to generate a downsampled image; and process the downsampled image using a super-resolution model to generate an output image.

Example 53 includes the non-transitory computer-readable medium of Example 52, wherein the synthetic blurring kernel matches a blurring kernel used to generate low-resolution images during training of the super-resolution model.

According to Example 54, a device includes a memory configured to store an input image; and one or more processors configured to generate a noise-added version of the input image; and process the noise-added version of the input image using a trained machine learning model to generate an output image, wherein generation of the noise-added version of the input image is based on an noise-adding operation that was used during training of the machine learning model.

Example 55 includes the device of Example 54, wherein the machine learning model corresponds to a denoiser; and wherein generation of the noise-added version of the input image includes application of synthetic noise to the input image to generate a noise-added image, the synthetic noise generated based on a first distribution associated with the training of the denoiser; and the output image having less noise than the input image.

Example 56 includes the device of Example 54, wherein the machine learning model corresponds to a super-resolution model; and wherein generation of the noise-added version of the input image includes: generation of an upsampled version of the input image having second size larger than a first size of the input image; application of a synthetic blurring kernel to the upsampled version of the input image to generate a blurred image, the synthetic blurring kernel matching a blurring kernel used to generate low-resolution images during the training of the super-resolution model; and generation of a downsampled version of the blurred image.

Example 57 includes the device of any of Examples 54 to 56 and further includes a display device configured to display the output image.

Example 58 includes the device of any of Examples 54 to 57 and further includes an image sensor configured to generate image data corresponding to the input image.

Example 59 includes the device of any of Examples 54 to 58 and further includes a modem coupled to the one or more processors, the modem configured to receive the input image from a second device.

Example 60 includes the device of any of Examples 54 to 59, wherein the one or more processors are integrated in a headset device that includes a display, and wherein the headset device is configured, when worn by a user, to display the output image at the display.

Example 61 includes the device of any of Examples 54 to 59, wherein the one or more processors are integrated in at least one of a mobile phone, a tablet computer device, a wearable electronic device, or a camera device.

Example 62 includes the device of any of Examples 54 to 59, wherein the one or more processors are integrated in a vehicle, the vehicle further including a display device configured to display the output image.

Example 63 includes the device of any of Examples 54 to 62, wherein the one or more processors are included in an integrated circuit.

According to Example 64, a method includes generating, at a device, a noise-added version of an input image; and processing, at the device, the noise-added version of the input image using a trained machine learning model to generate an output image, wherein generation of the noise-added version of the input image is based on a noise-adding operation that was used during training of the machine learning model.

Example 65 includes the method of Example 64, wherein the machine learning model corresponds to a denoiser; and wherein generating the noise-added version of the input image includes applying synthetic noise to the input image to generate a noise-added image, the synthetic noise generated based on a first distribution associated with the training of the denoiser; and the output image having less noise than the input image.

Example 66 includes the method of Example 64, wherein the machine learning model corresponds to a super-resolution model; and wherein generating the noise-added version of the input image includes: generating an upsampled version of the input image having second size larger than a first size of the input image; applying a synthetic blurring kernel to the upsampled version of the input image to generate a blurred image, the synthetic blurring kernel matching a blurring kernel used to generate low-resolution images during the training of the super-resolution model; and generating a downsampled version of the blurred image.

According to Example 67, an apparatus includes means for generating a noise-added version of an input image; and means for processing the noise-added version of the input image using a trained machine learning model to generate an output image, wherein generation of the noise-added version of the input image is based on a noise-adding operation that was used during training of the machine learning model.

Example 68 includes the apparatus of Example 67, wherein the machine learning model corresponds to a denoiser; and wherein generating the noise-added version of the input image includes applying synthetic noise to the input image to generate a noise-added image, the synthetic noise generated based on a first distribution associated with the training of the denoiser; and the output image having less noise than the input image.

Example 69 includes the apparatus of Example 67, wherein the machine learning model corresponds to a super-resolution model; and wherein generating the noise-added version of the input image includes: generating an upsampled version of the input image having second size larger than a first size of the input image; applying a synthetic blurring kernel to the upsampled version of the input image to generate a blurred image, the synthetic blurring kernel matching a blurring kernel used to generate low-resolution images during the training of the super-resolution model; and generating a downsampled version of the blurred image.

According to Example 70, a non-transitory computer-readable medium comprising instructions that, when executed by one or more processors, cause the one or more processors to generate a noise-added version of an input image; and process the noise-added version of the input image using a trained machine learning model to generate an output image, wherein generation of the noise-added version of the input image is based on a noise-adding operation that was used during training of the machine learning model.

Example 71 includes the non-transitory computer-readable medium of Example 70, wherein the machine learning model corresponds to a denoiser; and wherein generating the noise-added version of the input image includes applying synthetic noise to the input image to generate a noise-added image, the synthetic noise generated based on a first distribution associated with the training of the denoiser; and the output image having less noise than the input image.

Example 72 includes the non-transitory computer-readable medium of Example 70, wherein the machine learning model corresponds to a super-resolution model; and wherein generating the noise-added version of the input image includes: generating an upsampled version of the input image having second size larger than a first size of the input image; applying a synthetic blurring kernel to the upsampled version of the input image to generate a blurred image, the synthetic blurring kernel matching a blurring kernel used to generate low-resolution images during the training of the super-resolution model; and generating a downsampled version of the blurred image.

Those of skill would further appreciate that the various illustrative logical blocks, configurations, circuits, and algorithm steps described in connection with the implementations disclosed herein may be implemented as electronic hardware, computer software executed by a processing device such as a hardware processor, or combinations of both. Various illustrative components, blocks, configurations, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A device comprising:
a memory configured to store an input image; and
one or more processors configured to:
apply synthetic noise to the input image to generate a noise-added image; and
apply a denoiser to the noise-added image to generate an output image that has less noise than the input image.

2. The device of claim 1, wherein the denoiser is a blind denoiser.

3. The device of claim 1, wherein the input image includes a first amount of noise, and wherein the output image includes a second amount of noise that is less than the first amount.

4. The device of claim 1, wherein the one or more processors are further configured to generate the synthetic noise.

5. The device of claim 4, wherein the synthetic noise is generated based on a first distribution associated with training of the denoiser.

6. The device of claim 5, wherein noise in the input image is associated with a second distribution that is different from the first distribution and wherein the denoiser, during removal of the synthetic noise from the noise-added image, also removes at least some of the noise of the input image.

7. The device of claim 1, wherein the one or more processors are configured to:
apply multiple versions of synthetic noise to the input image to generate multiple noise-added images;
denoise each of the multiple noise-added images to generate multiple output images; and
combine the multiple output images to generate an ensemble output image.

8. The device of claim 1, further comprising a display device configured to display the output image.

9. The device of claim 1, further comprising an image sensor configured to generate image data corresponding to the input image.

10. The device of claim 1, further comprising a modem coupled to the one or more processors, the modem configured to receive the input image from a second device.

11. The device of claim 1, wherein the one or more processors are integrated in a headset device that includes a display, and wherein the headset device is configured, when worn by a user, to display the output image at the display.

12. The device of claim 1, wherein the one or more processors are integrated in at least one of a mobile phone, a tablet computer device, a wearable electronic device, or a camera device.

13. The device of claim 1, wherein the one or more processors are integrated in a vehicle, the vehicle further including a display device configured to display the output image.

14. The device of claim 1, wherein the one or more processors are included in an integrated circuit.

15. A method comprising:
applying, at a device, synthetic noise to an input image to generate a noise-added image; and
applying, at the device, a denoiser to the noise-added image to generate an output image that has less noise than the input image.

16. The method of claim 15, wherein the denoiser is a blind denoiser.

17. The method of claim 15, further comprising generating the synthetic noise based on a first distribution associated with training of the denoiser.

18. The method of claim 15, further comprising:
applying one or more additional versions of the synthetic noise to the input image to generate one or more additional noise-added images;
denoising each of the one or more additional noise-added images to generate one or more additional output images; and
combining the output image and the one or more additional output images to generate an ensemble output image.

19. A device comprising:
a memory configured to store an input image having a first size; and
one or more processors configured to:
upsample the input image to generate an upsampled image that has a second size larger than the first size;
apply a synthetic blurring kernel to the upsampled image to generate a blurred image;
downsample the blurred image to generate a downsampled image; and
process the downsampled image using a super-resolution model to generate an output image.

20. The device of claim 19, wherein the synthetic blurring kernel matches a blurring kernel used to generate low-resolution images during training of the super-resolution model.
